(19) United States
(12) Patent Application Publication
(10) Pub. No.: US 2008/0204754 A1
(43) Pub. Date: Aug. 28, 2008

(54) Device For Reconfigurable Processing Optical Beams

(75) Inventor: Christophe Martinez, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/996,848

(22) PCT Filed: Jul. 25, 2006
(86) PCT No.: PCT/EP2006/064648

§ 371 Date: Jan. 25, 2008

(30) Foreign Application Priority Data
Jul. 26, 2005 (FR) 05 52318

(51) Int. Cl. G01N 21/00; G02B 26/00

(52) U.S. Cl. 356/436; 359/291

(57) ABSTRACT

A device for optical processing of at least one main optical beam, including an optical transforming module contributing towards optical transformation of the main optical beam input in the processing device, formed of a plurality of discrete elements in one plane. An upstream spatial configuration module upstream of the optical transforming mode includes an optical pathway through which the main optical beam travels, this pathway includes one or more mobile optical deflection elements causing the main optical beam to take up potential spatial positions in the plane of the optical transforming module, these potential spatial positions coinciding with those of the discrete elements, the optical transforming module being static. Such a device may find application to telecommunications, chemistry, or biology.

### TECHNICAL AREA

The present invention relates to a reconfigurable device for the processing of optical beams.

The present invention particularly applies to optical communication systems in which the manufacturer endeavours to reduce manufacturing costs and the customer aspires for a system that has low consumption and is modular so that it is time-adaptive. This invention can be applied to other areas such as chemical or biological assays in which it is sought, as rapidly as possible and near-automatically, to evidence one or more substances contained in several samples of chemical or biological solutions.

### STATE OF THE PRIOR ART

Subsequent to the bursting of the economic bubble in the telecommunications sector, operators are seeking to limit their installation and operating costs. They give priority to fibre-optic optical systems which are time-adaptive without requiring a full upgrade.

These communications networks generally use wavelength multiplexing techniques. Multiplexers are known which allow the adding/dropping of optical signals towards an appropriate destination of the network, without having to convert them to electric signals, and which are reconfigurable. They are designated by the abbreviation ROADM for Reconfigurable Optical Add Drop Multiplexer. An optical beam conveying multiple data channels corresponding to different wavelength bands λ1, λ2, λ3, λ4, and guided by an optical fibre, is injected into the multiplexer at an input A. The multiplexer can allow the passing, or can block or possibly recover all or part of these channels in reconfigurable manner. One output is referenced A′ and can deliver one or more channels λ1, μ2, those which the multiplexer allows to pass. It is assumed in the example that it blocks channels λ3, λ4. Another output B can deliver one or more λ4 channels among the channels blocked by the multiplexer. A second input B′ is used to inject another optical beam which is processed in the multiplexer. It conveys channels λ′1, λ′2. It is assumed in this example that they will be transmitted and hence available at output A′. The multiplexer is reconfigurable when its functions can be activated or inactivated independently, as wished by the user.

From patent application US 2004/0136648 an optical processing device is known of ROADM type which, in cascade from an input port, comprises a diffraction grating, a focusing lens, a plurality of mobile mirrors and, in the vicinity of the input port, a plurality of output ports. An optical fibre conveying a plurality of wavelengths is injected into the multiplexer from an input port, it is separated into a plurality of optical beams according to their wavelength, and these beams are each routed towards a mobile optical deflecting element via the focusing lens. The mobile optical deflecting elements, depending on their position, reflect or do not reflect each of the optical beams towards a chosen output port during a return pathway via the lens and the diffraction grating. In this embodiment, a switching function is ensured by the mobile deflecting elements and a spectral dispersing function is ensured by the diffraction grating.

In patent application US2004/0252938 an optical processing device of ROADM type is also described. Starting from an input port, it comprises in cascade a selective planar input grating, a plurality of mobile optical deflection elements with analog control, a plurality of selective output gratings and a plurality of output ports. The selective planar input grating achieves both spectral dispersion and spatial dispersion, causing the generation of optical beams offset at an angle.

In the two preceding cases, it is the dispersing element which achieves both angle deviation and spectral dispersion. The multiplexer becomes complex the more the number of wavelengths to be separated increases. The assembly of the different mobile optical deflection elements, of the output ports and of the diffraction grating is difficult, alignment constraints are high.

From patent application WO 01/13151 a multiplexer is known in which a mobile optical transforming device formed of a plurality of elementary zones, including filtering elementary zones and a reflecting elementary zone, interacts with an incident optical beam. Depending on the configuration of the optical transforming device, its range of movement may be fairly extensive, which requires a complex and relatively slow actuator system. In addition, the presence of the complex actuator system prevents the optical transforming device from being interchangeable.

In the area of chemistry or biology, an optical processing device comprises an optical transforming device with a support provided with a plurality of wells arranged in an array in which samples of a liquid to be tested are placed. This support is able to move relative to an optical beam, so that it can irradiate the different samples. The movement of the support can only be obtained with an actuator device which is complex and relatively slow.

### DESCRIPTION OF THE INVENTION

The purpose of the present invention is to propose an optical processing device which does not have the above-mentioned limitations and difficulties.

In particular, one purpose is to propose a reconfigurable optical processing device of easy construction, which is low-cost to produce, has low electricity consumption and switching time, and which can be easily adapted over time to suit user needs.

To attain these objectives, the invention more specifically concerns an optical processing device to process at least one main optical beam. It comprises a module which optically transforms or contributes towards optical transforming the main optical beam input into the processing device, this device consisting of a plurality of discrete elements arranged in one same plane. Upstream of the optical transforming module, or module contributing towards optical transformation, it also comprises an upstream spatial configuration module having an optical pathway through which the main optical beam must pass, this pathway comprising one or more mobile optical deflecting elements intended to cause the main optical beam to take up potential spatial positions in the plane of the optical transforming module or contributing towards optical transformation, these potential spatial positions coinciding with those of the discrete elements, the optical transforming module or contributing towards optical transformation being static.

Therefore the difficulties encountered regarding the movement of prior art optical transforming modules are eliminated.

The discrete elements are static.

Amongst the discrete elements, at least one may be active and optionally one may be inactive.

An active discrete element may have a filtering, attenuating or absorbing function.

The discrete elements with filtering function may comprise a thin filter layer or several stacked thin filter layers. Their fabrication is simplified using techniques of thin layer type.

If the optical transforming module comprises several active discrete elements, preferably at least two active elements are different.

To facilitate the transition from one discrete element to another, at least one discrete element may be duplicated.

The discrete elements are preferably arranged in an array.

The upstream spatial configuration module may comprise another optical pathway through which an optical beam may travel that has been reflected by the optical transforming module or contributing towards optical transformation, this other optical pathway comprising one or more mobile optical deflection elements.

The optical processing device, downstream of the optical transforming module or contributing towards optical transformation, may comprise a downstream spatial configuration module comprising an optical pathway through which an optical beam may travel that has passed through the optical transforming module or contributing towards optical transformation, this pathway comprising one or more mobile optical deflection elements.

The downstream spatial configuration module may comprise another optical pathway intended to insert an auxiliary optical beam towards the optical transforming module or contributing towards optical transformation, this pathway comprising one or more mobile optical deflection elements.

An inactive discrete element may be transparent to the main optical beam and/or to the auxiliary optical beam.

Provision may be made so that the optical transforming module is able, individually and/or accumulated fashion, to filter several wavelengths contained in the main optical beam and/or in the auxiliary optical beam.

Each mobile optical deflection element has digital control (as opposed to analog control), which allows for reduced electricity consumption, only requires displacements over very short travel lengths (in the order of one micrometer or a dozen micrometers) and reduces switching times, these times possibly being less than a millisecond.

The upstream and downstream spatial configuration modules are symmetrical relative to the optical transforming module or contributing towards optical transformation.

Each spatial configuration module may comprise an angle-position transforming element placed between the mobile optical deflection elements and the optical transforming module or contributing towards optical transformation.

Since the angle-position transforming element has an object focal plane and an image focal plane, the optical transforming module or contributing towards optical transformation is placed substantially in the image focal plane of the angle-position transforming element of the upstream spatial configuration module, and in the object focal plane of the angle-position transforming element of the downstream spatial configuration module.

The angle-position transforming element is preferably common to all the optical pathways of its receiving spatial configuration module.

The mobile optical deflection elements may be mirrors, able to tilt about at least one axis.

Since the optical transforming module or contributing towards optical transformation is static, it can be interchangeable.

The module contributing towards optical transformation may comprise a support provided with several wells intended to receive liquid samples to be tested, these sample-containing wells forming the discrete elements.

A well may have a reflective or transparent base.

A discrete element may have a filter or attenuator function, or it may be excited when it contains a sample of liquid to be tested.

### BRIEF DESCRIPTION OF THE DRAWINGS

The present invention will be better understood on reading the description of examples of embodiment given purely for illustrative purposes and in no way limiting, with reference to the appended drawings in which:

FIG. 1 already described shows a prior art optical processing device of ROADM multiplexer type.

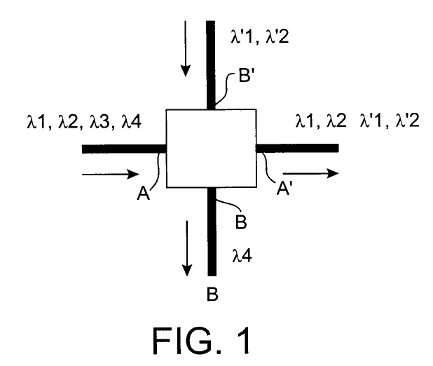

FIGS. 2A to 2D show an example of an optical processing device according to the invention in the different phases of operation.

FIG. 3 gives another example of an optical processing device in which the transforming module is of 4×4 type.

FIGS. 4 and 5 are diagrams explaining the sizing of an optical processing device of the invention.

FIG. 6 shows a casing containing an optical processing device of the invention having a removable optical transforming module.

FIGS. 7A to 7D and 8A to 8C illustrate two embodiments of an optical transforming module of an optical processing device of the invention.

FIGS. 9A to 9C, 10A to 10F, 11 illustrate several embodiments of the optimal transforming module of an optical processing device according to the invention.

FIG. 12 shows an optical processing device of the invention in which the optical transforming module has an attenuating function.

FIGS. 13A, 13B show two examples of an optical processing device of the invention which can be used in chemical or biological analysis applications.

Identical, similar or equivalent parts in the different figures described below carry the same reference numbers to facilitate cross-reading of the figures.

The different parts shown in the figures are not necessarily drawn to uniform scale, for better legibility of the figures.

### DETAILED DESCRIPTION OF PARTICULAR EMBODIMENTS

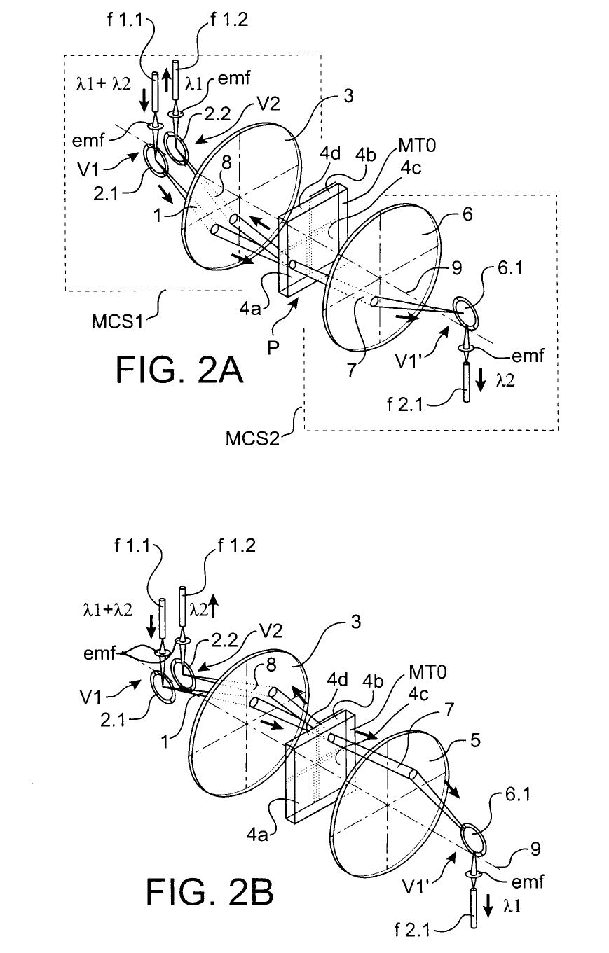

With reference to FIGS. 2A to 2D which show an optical processing device to process a main optical beam 1 according to the invention in several modes. It is assumed that the main optical beam 1 carries several wavelengths λ1, λ2. The processing device, in cascade, comprises an upstream spatial configuration module MCS1, an optical transforming module MTO and a downstream spatial configuration module MCS2.

The upstream spatial configuration module MCS1 comprises at least one optical pathway V1, through which the main optical beam 1 travels, with a mobile optical deflection element 2.1 able to deflect the main optical beam 1 to cause it to take up potential angular directions.

The mobile optical deflection elements may be digital control mirrors (preferably micro-mirrors) which can take up a finite number of stable, defined angle positions. Prisms or lenses could also be used. These angle positions may be taken up by causing the mirror to tilt about a single tilting axis or about several axes. These mirrors may for example have two tilt axes and two angle positions per axis. These stable angle positions of the mirror may be defined by abutments against which the mirror abuts. No abutment is shown so as not to overload the figures. It is not necessary to describe the mobile optical deflection elements in more detail, nor the control thereof, since they are optical components well known in the area of optical telecommunications.

The main optical beam 1 is conveyed by an optic fibre f1.1 before entering the processing device. A shaping element emf can be positioned between the end of the optic fibre f1.1 and the mobile optical deflection element 2.1.

Four potential directions are schematised in the four FIGS. 2A to 2D. The upstream spatial configuration module MCS1 also comprises an angle-position transforming element 3. This element 3 shown in the form of a lens has an optical axis 9 evidenced by a dotted line. By means of this element, the potential directions of the optical beams passing through it are made parallel. This angle-position transforming element 3 is reversible.

The optical beams following these directions will form distinct spots having a well determined positioned, in particular in an image focal plane of the angle-position transforming element 3. Downstream of the upstream spatial configuration module MCS1, there is positioned a module MTO optically transforming or contributing towards optically transforming the main optical beam 1 input into processing device of the invention. The optical transforming module or contributing towards optical transformation MTO is static.

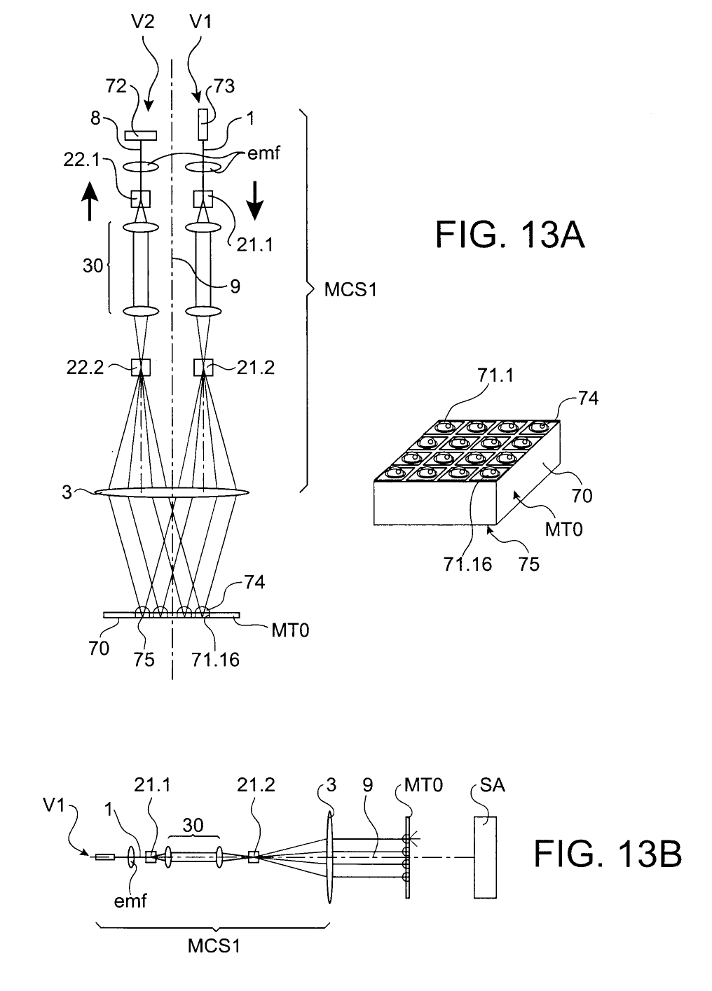

By optical transforming is meant filtering, total or partial attenuation, reflection, conversion. By the expression <<contributing towards optical transformation >> is meant that the module does not necessarily achieve optical transforming alone, such transforming can only take place if the module cooperates with material provided by the user of the processing device. One embodiment in which the module contributes to optical transforming is illustrated FIG. 13.

In the example shown FIG. 2, the MTO module is an optical transforming module. It comprises a plurality of discrete elements 4a to 4c of which at least two are different. The discrete elements 4a to 4c are static. At least one of these discrete elements 4a achieves transforming of the main optical beam 1 emerging from the upstream spatial configuration module MCS1 towards the transforming module MTO. The discrete element which carries out transforming of the main optical beam 1 is termed an active element. More generally, by active discrete element is meant a discrete element which achieves transformation or contributes towards transformation of the main optical beam 1, the meaning of transformation being given above. Below it will be seen that provision can be made for an auxiliary optical beam which may cooperate in the same manner as the main optical beam with the optical transforming module or which contributes towards optical transformation.

Provision may be made so that the optical transforming module MTO comprises at least one discrete element 4d which is inactive with respect to the main optical beam 1. This discrete element 4d can allow the main optical beam 1 to pass without modifying it. A discrete element which fully filters the optical beam by blocking it and reflecting it back towards the upstream spatial configuration module, or by absorbing it, is said to be active.

The discrete elements are arranged one beside the other in one same plane. These discrete elements are preferably distributed in an array with at least one row and at least one column. It is preferable for the transforming module MTO to be placed in the image focal plane of the angle-position transforming element 3.

In the example shown FIGS. 2A to 2D, the discrete element 4a is a spectral filter which reflects wavelength λ1 and allows wavelength λ2 to pass. The discrete element 4b is a spectral filter which reflects wavelength λ2 and allows wavelength λ1 to pass. The discrete element 4c is a reflective zone which fully reflects all wavelengths of the main optical beam 1 towards the upstream spatial configuration module MCS1, i.e. which fully filters the main optical beam 1. The discrete element 4d is a transparent zone which allows the main optical beam 1 to pass without modifying it (no filtering). In the example shown FIG. 2, the active discrete elements are referenced 4a, 4b, 4c and the inactive discrete element is denoted 4d.

Depending on the position taken up by the mobile optical deflection element 2.1, the main optical beam 1 will strike the optical transforming module MTO at one of these discrete elements 4a to 4d.

Reference number 7 is given to the optical beam which passes through the optical transforming module MTO irrespective of its processing or non-processing. Reference number 8 is given to the optical beam which is reflected by the optical transforming module MTO. Downstream and/or upstream of the optical transforming module MTO, there may be positioned a device using the optical beam after it has cooperated with the optical transforming module MTO.

FIG. 2, downstream of the optical transforming module MTO, show a downstream spatial configuration module MCS2 having at least one pathway V1′ allowing the optical beam 7, which has traveled through the optical transforming module MTO, to be routed towards an optic fibre f2.1 which acts as user device. Optical beam 7 corresponds to the output optical beam. A shaping element emf may be inserted between the mobile optical deflection element 6.2 and the end of the optic fibre f2.1. The downstream spatial configuration module MCS2 is symmetric with the upstream spatial configuration module MCS1 relative to the optical transforming module MTO. The optical pathway V1′ includes a mobile optical deflection element 6.1. The downstream spatial configuration module MCS2, in cascade, comprises an angle-position transforming element 5 and the mobile optical deflection element 6.1 of pathway V2. The angle-position transforming element 5 transforms the position of the optical beam 7, which has passed through the optical transforming module MTO, into an angular direction. The angle-position transforming element 5 functions for pathway V1′ in position-angle transformation since it is reversible. Optical beam 7 is deflected by the mobile optical deflection element 6.1 and is added to the output optic fibre f2.1.

Optical beam 8 which is reflected by the optical transforming module MTO passes through the upstream spatial configuration module MCS1 in reverse direction, the angle-position transforming element 3 directs it towards a mobile optical deflection element 2.2 which forms a second pathway V2 of the upstream spatial configuration module MCS1. It corresponds to the extracted optical beam. It can then be injected into an optic fibre f1.2 which acts as user device. A shaping element emf can be inserted between the mobile optical deflection element 2.2 and the end of the optic fibre f1.2.

If the upstream spatial configuration module comprises several pathways V1, V2, the angle-position transforming element 3 is common to all the pathways V1, V2. The same applies to the downstream spatial configuration module MCS2.

The mobile optical deflection elements 2.1, 2.2, 6.1 can be formed by mirrors (lenses or prisms) mobile about one or more rotation axes. In FIG. 2, each of the optical deflection elements is mobile about two substantially perpendicular axes and can take up four positions.

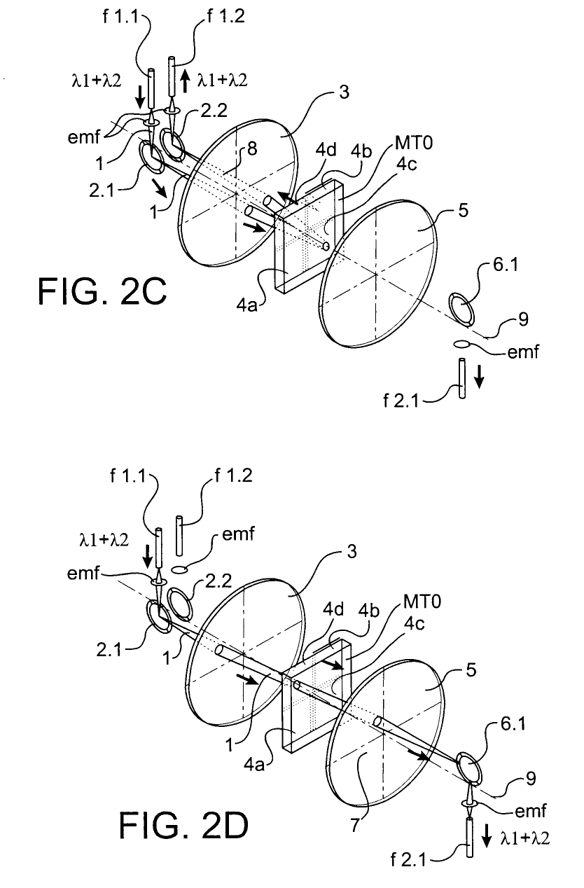

With reference to FIG. 3, a processing device of the invention will now be described in which the optical transforming module MTO comprises more than four discrete elements. There are 4×4 in the illustrated example and they are arranged in an array. The type of each of these discrete elements is not detailed in this example. It is assumed that some thereof are filters.

The main optical beam 1 can therefore take more potential directions, and for this purpose each pathway V1, V2, V1′, V2′ of the spatial configuration modules MCS1, MCS2 comprises a cascade of mobile optical deflection elements 21.1,21.2; 22.1,22.2; 21.1′, 21.2′; 22.1′,22.2′ separated by optical conjugation means 30, 40. In FIG. 3, for one pathway, two tiers of mobile optical deflection elements are shown, separated by optical conjugation means. Reference may be made to French patent WO 02/071126 which describes this principle of angular amplification.

The optical conjugation means 30,40 may, for one pathway, be formed of one or more lenses in series for example. In FIG. 3, these lenses form a doublet. The lenses do not carry any reference. Each mobile optical deflection element 21.1, 21.2 of a pathway V1 in the cascade is optically conjugate with the mobile optical deflection element 21.2, 21.1 following or preceding it through an object-image relationship via the optical conjugation means 30.

Another difference can be seen FIG. 3 compared with the configuration shown FIG. 2. A second pathway V2′ is provided in the downstream spatial configuration module MCS2. It is intended for injection of an auxiliary optical beam 10 directed onto the optical transforming module MTO for cooperation therewith. The auxiliary optical beam 10 conveys two wavelengths λ1′, λ3′, these two wavelengths are the same as wavelengths λ1, λ3 of optical beam 1. Different names are given to indicate that the main optical beam 1 and the auxiliary optical beam 10 convey different signals having the same wavelengths.

It is assumed that the structure of the second optical pathway V2′ is substantially identical to the structure of optical pathway V1′ with two mobile optical deflection elements 22.1′, 22.2′ separated by optical conjugation means 40. In the described example, the auxiliary optical beam 10 interacts with the same discrete element as the main optical beam 1 to be transmitted or reflected by the optical transforming module. In the example, the auxiliary optical beam 10 is fully reflected by the optical transforming module MTO towards the optical pathway V1′.

Other configurations can be envisioned, and in particular the auxiliary optical beam may pass through the optical transforming module without any change by an inactive discrete element.

In each of the spatial configuration modules MCS1, MCS2 the angle-position transforming element 3, 5 is common to all the pathways (V1, V2), (V1′, V2′).

In this example the main optical beam 1, which enters the processing device via the first pathway V1 of the upstream spatial configuration module MCS1, conveys four wavelengths λ1, λ2, λ3, λ4. The optical beam 8 which emerges from the upstream spatial configuration module MCS1 only conveys two of the wavelengths λ1, λ3 of the main optical beam 1. The optical transforming module MTO has reflected these two wavelengths by filtering the input main optical beam 1. The optical beam 7 leaving the downstream spatial configuration module MCS2 conveys two of the wavelengths λ2, λ4 of the main optical beam 1. The optical transforming module MTO, by filtering, has transmitted these two wavelengths of the main optical beam 1. The optical transforming module MTO has reflected, by filtering, the two wavelengths λ1′, λ3′ of the auxiliary optical beam 10.

The optical beam 7 which emerges via pathway V1′ of the downstream spatial configuration module MCS2 therefore also conveys the two wavelengths λ1′, λ3′ of the auxiliary optical beam 10 injected into the second pathway V2′ of the downstream spatial configuration module MCS2.

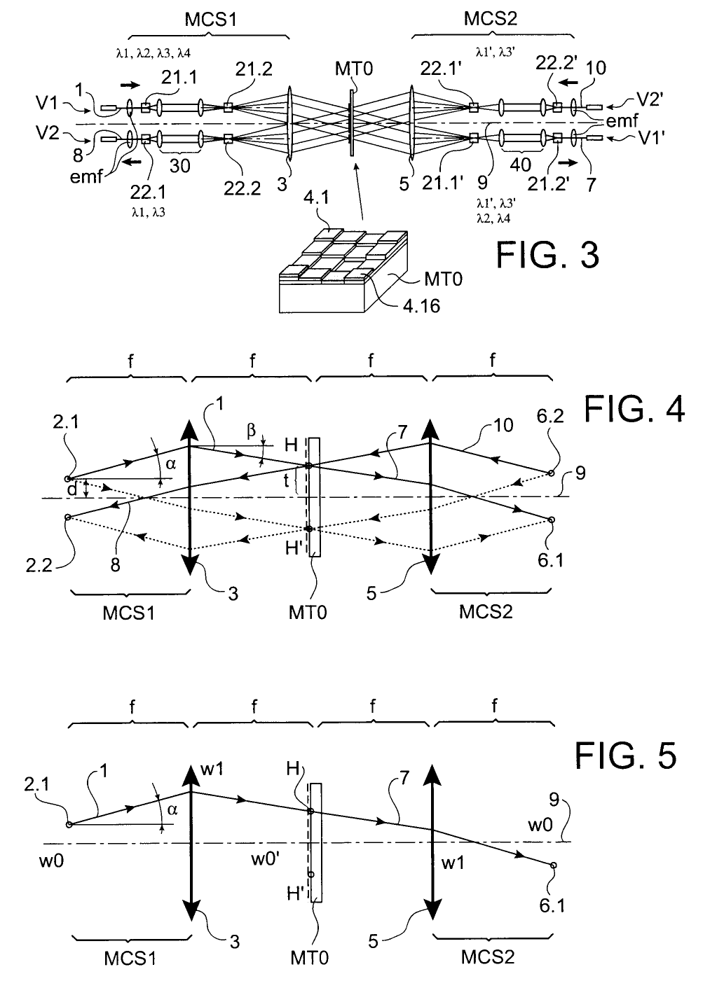

We now turn our attention to FIG. 4 which allows us to better apprehend the sizing of the processing device subject of the invention. It is assumed that the angle-position transforming elements 3, 5 of the upstream and downstream spatial configuration modules MCS1, MCS2 have the same focal length f. For each of the pathways V1, V2 of the upstream spatial configuration module MCS1, only those mobile optical deflection elements 2.1, 2.2 are shown which are closest to the angle-position transforming element 3. For each of the pathways V1′, V2′, of the downstream spatial configuration module MCS2, only the mobile optical deflection elements 6.1, 6.2 are shown which are the closest to the angle-position transforming element 5.

The optical transforming module MTO is placed in the image focal plane of the angle-position transforming element 3 of the upstream spatial configuration module MCS1 and in the object focal plane of the angle-position transforming element 5 of the downstream spatial configuration module MCS2. The mobile optical deflection elements 2.1, 2.2 of the upstream spatial configuration module MCS1 are placed in the object focal plane of the angle-position transforming element 3 of the upstream spatial configuration module MCS1. The mobile optical deflection elements 6.1, 6.2 of the downstream spatial configuration module MCS2 are placed in the image focal plane of the angle-position transforming element 5 of the downstream spatial configuration module MCS2.

Depending on the positions of the mobile optical deflection elements, all the potential main optical beams 1 leaving the angle-position transforming element 3 of the upstream spatial configuration module MCS1 are parallel. All the optical beams which enter the downstream spatial configuration module MCS2 via the angle-position transforming element 5 are also parallel.

The optical axis 9 of the angle-position transforming elements is traced. The optical deflection element 2.1 is spaced away from this optical axis by a distance d. The main optical beams which emerge from the upstream spatial configuration module MCS1, after passing through the angle-position transforming element 3, are deviated by an angle β with respect to the optical axis 9. Geometrically, for a focal length f much greater than distance d, angle β is expressed as:

β=d/f

α denotes the angle of deviation relative to the optical axis 9 of the main optical beam 1 downstream of the mobile optical deflection element 2.1. This optical beam is intercepted at point H by the optical transforming module MTO, this point H lies at a distance t from the optical axis 9. This distance t, if distance t is much smaller than focal length f, is expressed by:

t=α·f

If the different optical beams deflected by the mobile optical deflection element 2.1 can be separated by an angle 2α when the mobile optical deflection element takes up two different positions, the pitch p between the discrete elements of the optical transforming module MTO is 2t. If 2α equals 3° and f=25 millimetres, then the pitch p equals 1.3 millimetres.

FIG. 5 reproduces the case in the preceding figure and attention is now given to the divergence of the main optical beam 1 following the formalism of Gaussian optics. The minimum radius or <<waist>> of the main optical beam 1 is denoted w0 just after it has been deflected by the mobile optical deflection element 2.1 that is closest to the angle-position transforming element 3 of the upstream spatial configuration module MCS1. This parameter determines the characteristics of the optical beam and in particular its divergence. At the angle-position transforming element 3, the radius of the main optical beam becomes w1. It has diverged between the mobile optical deflection element 2.1 and the angle-position transforming element 3. The <<waist>> of the optical beam 1 becomes w0′ at the optical transforming module MTO. Insofar as the two angle-position transforming elements 3, 5 are the same and the optical transforming module MTO is positioned in their image and object focal plane respectively, the <waist>> of the optical beam 7 travelling through the downstream spatial configuration module MCS2 at the mobile optical deflection element 6.1 closest to the angle-position transforming element 5 is that of the main optical beam originally, w0. The two angle-position transforming elements, in addition to their geometric function transforming an angle direction into a position and vice versa, have an imaging action with respect to the divergence of the main optical beam 1 by imaging the <<waist>> w0 into <<waist >> w0′ at the optical transforming module MTO.

If w0=100 micrometers, f=25 millimetres and if the wavelength of the optical beam is in the order of 1550 nanometres, then w0′ equals approximately 120 micrometers. Thereupon it is deduced that the pitch p, calculated previously, is largely greater than w0′, which indicates that the lateral positioning of the optical transforming module MTO is scarcely constrained compared with the optical beam cooperating with it. This remark is also valid for the accuracy regarding angle α which defines the positioning of the main optical beam 1 relative to the optical transforming module MTO. This property is of particular advantage since the positioning accuracy of the optical transforming module MTO can be in the order of at least 100 micrometers. The diameter of the angle-position transforming element 3 must be sufficiently large so as not to block the optical beam 1 of radius w1.

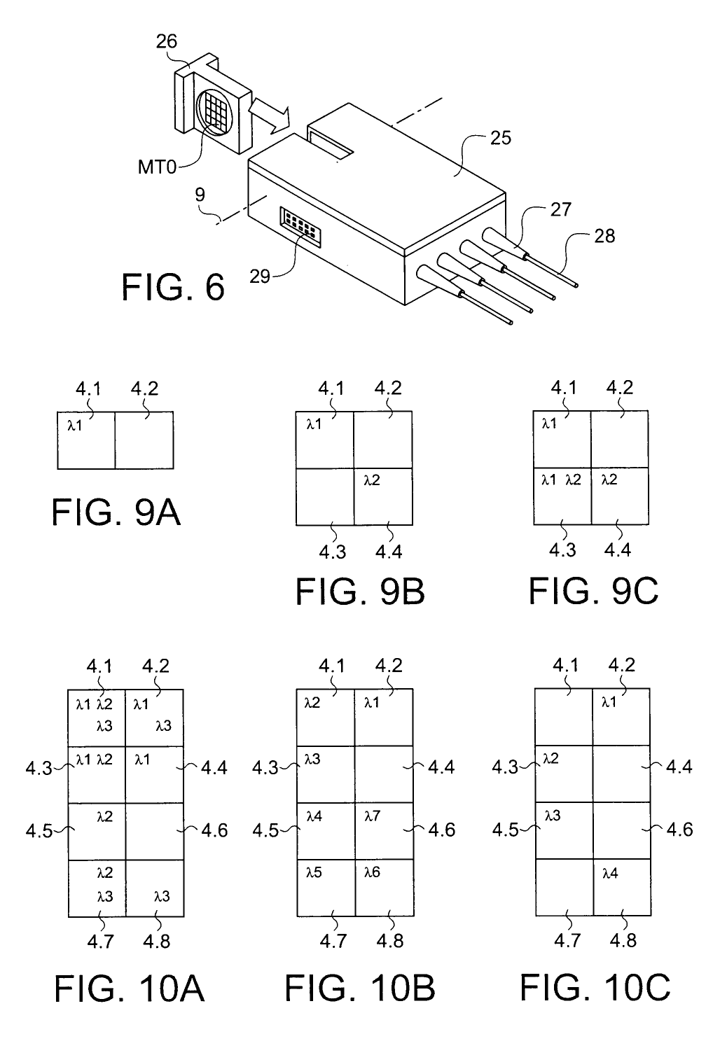

FIG. 6 gives a global view of a processing device subject of the invention. A casing 25 is schematised intended to contain the spatial configuration modules (not shown) and the optical transforming module MTO. The latter is interchangeable. It is shown cooperating with a mechanical structure 26 sliding in the casing 25. This mechanical structure holds it substantially perpendicular to the optical axis 9. Reference 27 denotes input/output ports cooperating with optic fibres 28. Reference 29 illustrates electric connections supplying power to the control means of the mobile optical deflection elements.

Said processing device can be easily assembled, care must be taken to ensure that the sliding mechanical structure 26 properly renders the optical transforming module MTO perpendicular to the optical axis 9. The manufacturing cost of said device is therefore relatively low. Various optical transforming modules MTO may be available on the market and several thereof may be acquired by the client to suit changing needs, this being possible owing to the low positioning tolerance. This advantage is of major interest. The casing and its content, with the exception of the removable optical transforming module, can be mass produced for all kinds of applications. Clients' requests are merely met by the choice of the optical transforming module(s) to be purchased. The manufacturer can place a modular product on the market which is cheap to produce. A processing device purchased by a client is easily adaptive, by changing the optical transforming module. Additionally, the maintenance of said device is easy, if one of the optical deflection elements should become deteriorated, it can be easily changed and there is no need to change the entire device. The other components of the processing device are fixed and are therefore sturdier than mobile components.

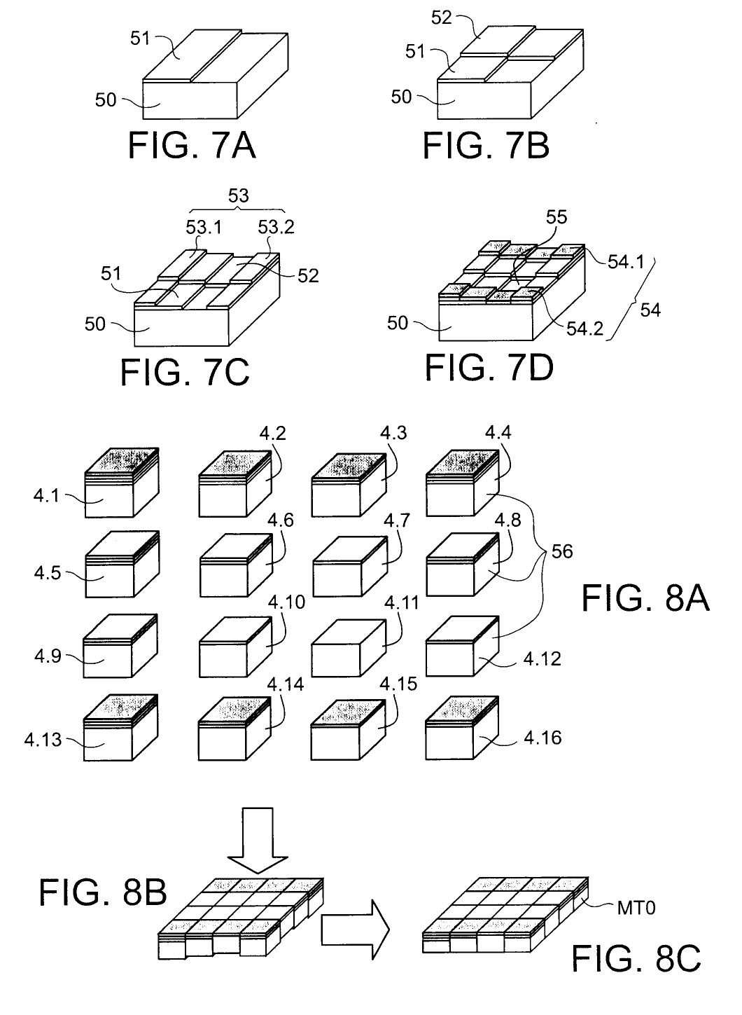

We will now turn our attention to FIGS. 7A to 7D which show a method to produce an optical transforming module MTO such as shown FIG. 3. It is assumed in this example that the optical transforming module MTO is formed of 4×4 discrete elements arranged in a paved array. Among these sixteen discrete elements, fifteen are active and have different filtering functions, and one is inactive and is transparent with respect to the optical beam striking it. It is assumed in this example that the optical transforming module is intended to filter, in whole or in part, an optical beam conveying four wavelengths λ1, λ2, λ3, λ4.

The starting product is a base substrate 50 of a size corresponding to the desired dimensions for the optical transforming module MTO.

In the example, the base substrate 50 is shown with a substantially square front face. It can be obtained for example by cutting a substrate of conventional size after the series of filter layer deposits described further on. The fabrication of the active discrete elements is based on the superimposition of filters following a matrix distribution. A first filter layer 51 is arranged on substantially one half of the front face of the base substrate 50 (FIG. 7A). It runs along one of its sides. It is assumed that it stops wavelength λ1, e.g. by reflection, and that it allows the other wavelengths λ2, λ3, λ4 to pass. A second filter layer 52 is then deposited, it takes up substantially one half of the front face of the base substrate 50, and runs along another side contiguous with the first side. It directly covers one quarter of the base substrate 50 and one half of the first layer 51 (FIG. 7B). It stops wavelength λ2, e.g. by reflection, and allows the others λ1, λ3, λ4 to pass.

A third layer 53 is then deposited, it takes up substantially one half of the front face of the base substrate 50, it is sub-divided into non-contiguous, parallel, substantially identical strips 53.1, 53.2, one running along the first side and the other along a third side opposite the first side (FIG. 7C). The third layer 53 stops wavelength λ3, e.g. by reflection, and allows the others λ1, λ2, λ4 to pass. One of the strips (reference 53.1) directly covers one quarter of the first layer 51 and therefore also impinges on one quarter of the second layer 52 at the point where this layer covers the first layer 51. The other strip (reference 53.2) directly covers one eighth of the front face of substrate 50 and therefore also impinges on one quarter of the second layer 52 at the point where this second layer directly covers the front face of substrate 50.

A fourth layer 54 is then deposited, it substantially takes up one half of the front face of the substrate, it is sub-divided into two non-contiguous, parallel, substantially identical strips 54.1, 54.2, one running along the second side and the other along a fourth side opposite the second side (FIG. 7D). The fourth layer 54 stops wavelength λ4, e.g. by reflection, and allows the others λ1, λ2, λ3 to pass. One of the strips (reference 54.1) directly covers one quarter of each of the strips 53.1, 53.2 of the third layer 53 at the points where it covers the second layer 52 and also impinges directly on one quarter of the second layer 52. The other strip (reference 54.2) directly covers one quarter of each of strips 53.1, 53.2 at the points where one covers the first layer 51 and the other covers the front face of substrate 50 and also impinges directly on one eighth of the first layer 51, at a point where the latter directly covers the front face of substrate 50, and on one sixteenth of the main face of substrate 50. Only one sixteenth 55 of the front face of substrate 50 remains bare, and forms the inactive discrete element. It is transparent and allows all wavelengths λ1, λ2, λ3, λ4 to pass. Transparency is obtained using a base substrate 50 in glass or silicon for example, if the wavelength domain concerns telecommunications bands around 1.55 micrometers.

The different layers of filters are deposited for example using technologies of thin layer type well known in microelectronics, and are delimited from each other using technologies of lithography or masking type given the relatively large dimensions of the pitch between the discrete elements. The transforming module MTO then has sixteen different combinations to filter all the initial four wavelengths λ1, λ2, λ3, λ4, encompassing total filtering and zero filtering. This is an elegant configuration since it is solely based on masking and depositing technologies, and allows volume fabrication of the optical transforming module. For more fine-tuned filtering needs, i.e. with narrow filters positioned precisely in the spectrum, this fabrication mode may give a poor yield, since if the last layer does not lead to discrete elements conforming to specifications, the optical transforming module in its entirety will have to be discarded.

A second embodiment of an optical transforming module is illustrated FIGS. 8A to 8C. Each of the discrete elements 4.1 to 4.16 is fabricated independently from support blocks 56. On fifteen thereof a suitable filter is deposited from one or more stacked filter layers. The fifteen filters correspond to the above-described combinations. One block 4.11 remains bare, it will give the inactive discrete element which allows all the wavelengths to pass. The sixteen blocks 4.1 to 4.16 are then grouped in an array and assembled one to another e.g. using glue (FIG. 8B), the faces carrying the filters all lying on one same side and contained in one same plane. A cutting step may be provided, to cut each of the blocks to obtain the desired pitch before assembly. Finally, a polishing step may be performed on the assembly obtained, opposite the face carrying the filters (FIG. 8C) to rectify the thickness of the optical transforming module.

The different manners will now be described in which to combine the discrete elements of the optical transforming device of the optical processing device of the invention. The number of discrete elements of the optical transforming module depends on the composition of the upstream spatial configuration module (and downstream module if any) and more particularly on the number of tiers of mobile optical deflection elements and on the number of positions they can take up. It is assumed hereunder that each mobile optical deflection element can take up two positions per axis of rotation.

If the upstream spatial configuration module comprises a singe tier as in FIG. 2, the transforming module will have 2 discrete elements if the mobile optical deflection element is mobile about a single axis, and 2×2 discrete elements if the mobile optical deflection element is mobile about two axes. The number of mobile optical deflection elements lies between 2 and 4.

If the upstream spatial configuration module comprises two tiers of mobile optical deflection elements as in FIG. 3, the optical transforming module may be formed of:
2×2 discrete elements if each mobile optical deflection element has one axis of rotation and if the two axes are crossed;
4×1 discrete elements if each mobile optical deflection element has one axis of rotation and if the two axes are parallel to each other;
4×2 discrete elements if one of the mobile optical deflection elements has one axis of rotation and the other has two axes;
4×4 discrete elements if the two mobile optical deflection elements have two axes of rotation.

The number of mobile optical deflection elements lies between 4 and 16 and more generally between 2ⁿ and 4ⁿ if the spatial configuration module has n tiers.

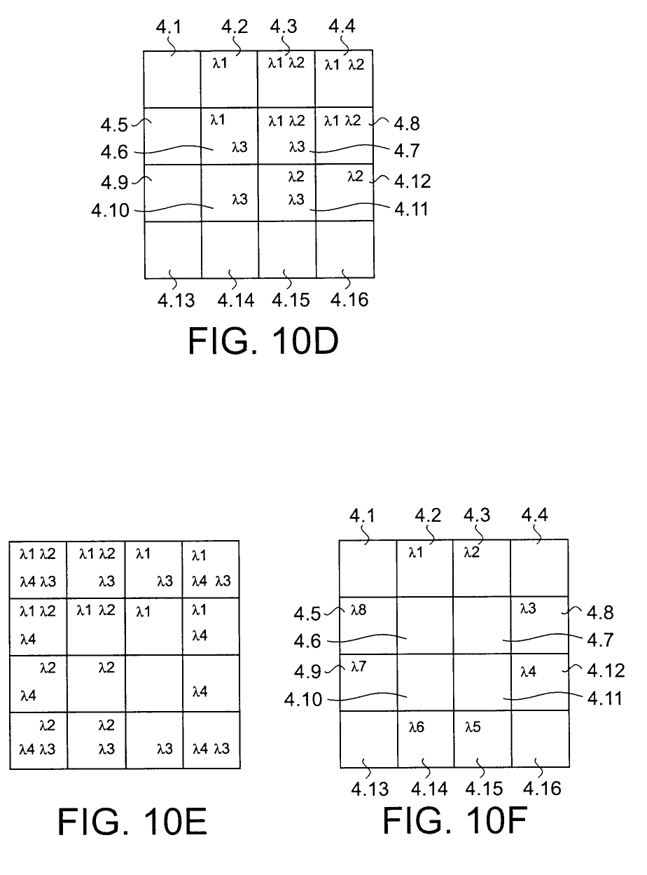

Reference is now made to FIGS. 9A to 9C. In these and the following figures which illustrate an optical transforming module, the active discrete elements are shaded and the inactive discrete elements are white. In FIG. 9A, the simplest case is shown of an optical transforming module with two discrete elements 4.1, 4.2 (of 2×1 type) side by side. The discrete element 4.1 filters wavelength λ1 while allowing all the others to pass. It can reflect a signal at this wavelength λ1 towards the upstream spatial configuration module or towards the downstream spatial configuration module, depending on whether consideration is given to the main incident optical beam 1 travelling through pathway λ1 in FIG. 3 or to the auxiliary incident optical beam 10 travelling through pathway V2′ in FIG. 3. This amounts to saying that it can extract or insert wavelength λ1. The other discrete element 4.2 is transparent to this wavelength, it allows it to pass without reflecting it. It is preferably provided with anti-reflection treatment at this wavelength.

FIGS. 9B and 9C are other examples of optical transforming modules to be associated with a one-tiered upstream spatial configuration module. The optical transforming module in FIG. 9B, of 2×2 discrete element type, comprises a discrete element 4.1 intended to filter wavelength λ1, and a discrete element 4.4 intended to filter wavelength λ2 which are arranged diagonally, and two discrete elements 4.2, 4.3 that are transparent to these two wavelengths. This optical transforming module is able to filter, reconfigurable fashion, two wavelengths λ1, λ2 individually.

The optical transforming module in FIG. 9C, of 2×2 discrete element type, comprises a discrete element 4.1 intended to filter wavelength λ1, a discrete element 4.4 intended to filter wavelength λ2 arranged diagonally, a discrete element 4.3 intended to filter both wavelength λ1 and wavelength λ2, and a discrete element 4.2 transparent to these two wavelengths. The discrete elements 4.2 and 4.3 are arranged diagonally. This transforming module is capable of filtering, reconfigurable fashion, two wavelengths λ1, λ2 individually and/or accumulated fashion.

FIGS. 10A to 10F show various embodiments of optical transforming modules to be associated with a two-tiered upstream spatial configuration module.

The optical transforming module in FIG. 10A is of 2×4 discrete element type. It is capable of filtering, reconfigurably, three wavelengths λ1, λ2, λ3 individually and/or accumulated fashion. For the discrete elements the same references have been used as in FIG. 9 to indicate their functions. This module has a discrete element transparent to these wavelengths.

The optical transforming module in FIG. 10B is of 2×4 discrete element type. It is capable of filtering, reconfigurable fashion, seven wavelengths 1λ1, λ2, λ3, λ4, λ5, λ6, λ7 individually. The same reference numbers are used in the discrete elements as in FIG. 9 to indicate their functions. It has a discrete element 4.4 transparent to these wavelengths.

The configuration in FIG. 10B may have a drawback in terms of utilisation. Insofar as discrete elements filtering different wavelengths lie adjacent to each other, when an incident optical beam must switch from one discrete element e.g. 4.7 intended to filter wavelength λ5, to another element e.g. 4.2 intended to filter wavelength λ1, at the time of transition the optical transforming module will filter other wavelengths e.g. λ4, λ3, λ2 passing through discrete elements 4.5, 4.3, 4.1. Said non-desired filtering may hamper some applications. If it is desired to avoid this effect, the configuration of the discrete elements must be reviewed and in particular inactive discrete elements must be added which are transparent to the wavelengths present. The optical transforming module in FIG. 10C avoids this disadvantage.

This optical transforming module of 2×4 discrete element type is capable of filtering, reconfigurable fashion, four wavelengths λ1, λ2, λ3, λ4 individually. It comprises four active discrete elements 4.2, 4.3, 4.5, 4.8 which each filter a wavelength λ1, λ2, λ3, λ4 respectively. It also comprises four inactive discrete elements 4.1, 4.4, 4.6, 4.8 which are transparent to these wavelengths. Each active discrete element is adjacent to two inactive discrete elements. Switching from one active discrete element to another active element, which is not contiguous to it, can only be achieved via one or more inactive discrete elements. For example, the switching from active discrete element 4.2 to active discrete element 4.8 is made via inactive discrete elements 4.4, 4.6.

The transforming modules in FIGS. 10D to 10F are of 4×4 discrete element type. The optical transforming module in FIG. 10D comprises a set of 3×3 active discrete elements (4.2 to 4.4, 4.6 to 4.8, 4.10 to 4.12) that are contiguous and able to filter in reconfigurable manner three wavelengths λ1, λ2, λ3 individually and/or accumulated fashion. The discrete elements 4.3, 4.4, 4.7 are identical, they are capable of filtering the two wavelengths λ1, λ2. It also comprises a group of seven inactive edging discrete elements referenced 4.1, 4.5, 4.9, 4.12 to 4.16. The group of edging elements is transparent to the three wavelengths λ1, λ2, λ3.

This optical transforming module is an improvement on the one in FIG. 10A. In the example shown FIG. 10A, if it is desired to switch as directly as possible from discrete element 4.2 which filters the two wavelengths λ1 and λ3 over to discrete element 4.8 which filters wavelength λ3, it is necessary to pass successively through discrete element 4.4 which filters wavelength λ1 and discrete element 4.6 which is transparent. Therefore for a fraction of the transition time the filtering of wavelength λ3 is lost. In FIG. 10D, during the transition between the discrete element 4.3 which filters the two wavelengths λ1 and λ2 and discrete element 4.12 which filters wavelength λ2, transition is made via discrete elements 4.4 and 4.7 which also filter the two wavelengths λ1 and λ2. No signal is lost on account of the duplicated discrete elements.

The optical transforming module in FIG. 10E proposes an individual and/or accumulated filtering function of four wavelengths λ1, λ2, λ3, λ4. This optical transforming module is similar to the one described in FIGS. 3, 7, 8. It has the same drawback as the one in FIG. 10A.

As a general rule, if during the changeover from one discrete element to any another of the optical transforming module, the transition phase does not give rise to any problem, individual and/or accumulated filtering of an optical beam conveying NI wavelengths requires 2^{NI} different discrete elements. An upstream spatial configuration module having p tiers allows the optical beam to take up between 2^{p} and 2^{2p} separate positions on the optical transforming module.

The minimum number of tiers required to conduct individual and/or accumulated filtering of NI wavelengths is NI/2 if NI is even and (NI+1)/2 if NI is uneven. Therefore if NI equals 4, the upstream spatial configuration module must comprise two tiers.

The optical transforming module in FIG. 10F shows a configuration of an optical transforming module able to filter, in reconfigurable manner, eight wavelengths individually with management of the transition phase between any two non-contiguous discrete elements. In this configuration, the transforming module is of 4×4 discrete element type, these being divided into eight active discrete elements 4.2, 4.3, 4.5, 4.8, 4.9, 4.12, 4.14, 4.15 and eight passive discrete elements 4.1, 4.4, 4.6, 4.7, 4.10, 4.11, 4.13, 4.16.

The active discrete elements each filter a different wavelength λ1 to λ8 and allow the others to pass. The inactive discrete elements are transparent to all the wavelengths in presence. The active discrete elements lie on the edge of the array. They each lie adjacent to two inactive discrete elements. The switching from one active discrete element to any other is made either directly since they are adjacent, or passing through one or more inactive discrete elements.

FIG. 11 shows a configuration of an optical transforming module of 8×8 discrete element type, arranged in an array and able to filter in reconfigurable manner 36 wavelengths λ1 to λ36 individually with management of the transition phase. It comprises 64 discrete elements arranged in an array of which 36 are active discrete elements and 36 are inactive discrete elements. The distribution of the active discrete elements is such that they lie on the edge of the array with the exception of the corners and an H-shaped island 60 is arranged in the central part of the optical transforming module, this island being fully surrounded by inactive discrete elements. In the corners there are also inactive discrete elements. Each active discrete element lies adjacent to one or more inactive discrete elements. The switching from one active discrete element to any other active discrete element can be made either directly since they are adjacent, or via one or more inactive discrete elements.

The active discrete elements each filter a different wavelength λ1 to λ36 and allow the others to pass. The inactive discrete elements are transparent to the wavelengths in presence. The upstream spatial configuration module which is to cooperate with the optical transforming module may have at least three tiers and mobile optical deflection elements able to take up four positions by means of rotations about two axes.

The number of tiers and the type of mobile optical deflection elements of the downstream spatial configuration module will be similar to those of the upstream spatial configuration module.

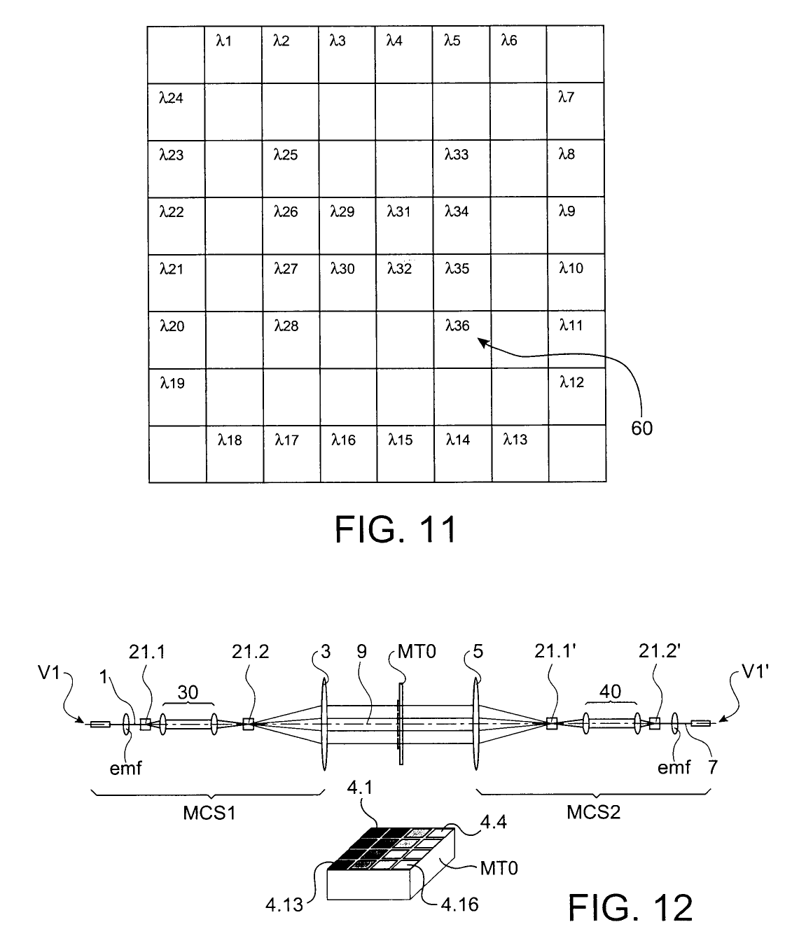

Our attention will now turn to another embodiment of an optical processing device according to the invention, with reference to FIG. 12 in connection with FIG. 3. The processing device, as in FIG. 3, comprises a cascade with an upstream spatial configuration module MCS1, an optical transforming module MTO and a downstream spatial configuration module MCS2. Each of the spatial configuration modules MCS1, MCS2 comprises two tiers of mobile optical deflection elements 21.1, 21.2 and 21.1′, 21.2′, each of the mobile optical deflection elements possibly taking up two separate positions. In this example each of the spatial configuration modules MCS1, MCS2 comprises a single optical pathway, respectively V1, V1′. The optical transforming module MTO, instead of having a filtering function, now has an attenuating function. It comprises 4×4 discrete elements arranged in an array. Among these discrete elements, it is assumed that fifteen thereof are active and different. They generate different attenuations of the intensity of main optical beam 1, starting with total attenuation provided by discrete element 4.1. This discrete element 4.1 fully absorbs the main optical beam 1. The last discrete element 4.16 is passive, it does not provide any attenuation, it is transparent to the incident optical beam 1. The attenuations brought by the discrete elements of this optical transforming module decrease column by column, from top to bottom and from left to right with reference to the optical transforming module MTO seen in three dimensions in FIG. 12. The discrete element 4.1 is placed in the top of the left column, discrete element 4.13 in the bottom of the left column, discrete element 4.4 in the top of the right column and discrete element 4.16 in the bottom of the right column. Switching from one discrete element to another, following the order set forth above, allows progressive scanning of possible attenuations.

In this example, since there is only one optical pathway per spatial configuration module MCS1, MCS2, the processing device of the invention is centred on axis 9 which is the axis of the angle-position transforming elements 3, 5 of the upstream and downstream spatial configuration modules MCS1, MCS2. It would be possible to provide for a reflection pathway in the upstream spatial configuration module MCS1 and/or an insertion pathway in the downstream spatial configuration module MCS2.

Said processing device whose mobile optical deflection elements have digital control, offers switchable ranges of calibrated attenuation that are easier to manager than with conventional analog attenuators.

FIGS. 13A, 13B show optical processing devices according to the invention which lie outside the area of telecommunications. They can be used in the are of chemical or biological analysis. In FIG. 13A, it is assumed that the optical processing device only comprises one upstream spatial configuration module MCS1 followed by a module MTO contributing towards optical transformation, the downstream spatial configuration module not being shown. This upstream spatial configuration module MCS1 is similar to the one illustrated FIG. 3. In other configurations of chemical or biological analysis, it is possible however to use a downstream spatial configuration module if the bottom of the wells is transparent to the main optical beam 1 passing through the liquid they contain. This downstream spatial configuration module may be similar to the one in FIG. 3 with two optical pathways. This downstream spatial configuration module is not shown to avoid unnecessary multiplication of the figures.

The upstream spatial configuration module MCS1 is similar to the one shown FIG. 3 with two optical pathways V1, V2 and two tiers of mobile optical deflection elements 21.1, 21.2, 22.1, 22.2. The main optical beam 1 does not necessarily convey several wavelengths as will be seen below. The module contributing towards optical transformation MTO has a substantially planar support 70 provided with a set of wells 71.1 to 71.16 intended to receive liquid samples also called solutions to be tested. Not all the wells are referenced, but their numbering is similar to that of the discrete elements in FIG. 10F. Wells 71.1 to 71.16 are arranged in an array on the surface of the support 70. These wells form the discrete elements of the module contributing towards optical transformation MTO. The test can take place when the wells 71.1 to 71.16 are filled with samples 74 of liquids to be tested. The main optical beam 1 emerges from the upstream spatial configuration module MCS1, conveyed by optical pathway V1, and is intercepted by the module contributing towards optical transformation MTO. It is able to illuminate each well by switching from one to another. The tests may be spectrophotometry tests. If the test consists of measuring loss at a given wavelength, the main optical beam 1 is tuned with this wavelength. The bottom 75 of the wells is reflective. It may be emitted by a tuneable source 73. The main optical beam 1, by illuminating one of the wells, enters into the sample 74 to be tested contained therein, passes through it, is reflected against the bottom 75 and passes through sample 74 again before being collected by the second optical pathway V2. The reflected optical beam then carries reference number 8. On leaving the upstream spatial configuration module MCS1, the reflected optical beam 8 is either injected into an optical fibre towards a user device (not shown) or directly illuminates the user device 72 which can evaluate the loss. This user device may be a detector.

If it is a spectral test, the source 73 may be wideband and the user device 72 may be a spectrum analyser.

It may be envisioned to use the optical processing device of the invention to conduct fluorescence tests. Reference is made to FIG. 13B. This configuration comprises a cascade with an upstream spatial configuration module MCS1 and a module contributing towards optical transformation MTO. A user device e.g. an acquisition system SA comprising a sensor is positioned downstream of the module contributing towards optical transformation MTO.

The main optical beam 1, when it illuminates a sample 74 contained in one of the wells 71.1, excites a fluorescent marker contained therein. Fluorescence is emitted in all directions. If the bottom of the wells is transparent, the fluorescence emitted by each well whose sample has been excited, passes through the bottom of the well and is acquired and analysed by the acquisition system SA.

The different variants described are to be construed as not being exclusive of each other.

Although several embodiments of the present invention have been illustrated and described in detailed manner, it will be appreciated that different changes and modifications may be made thereto without departing from the scope of the invention, in particular the distribution of the active and inactive discrete elements is in no way limiting.

The terms left, right, top, bottom apply to the embodiments shown and described with reference to the figures. They are used solely for the needs of the description and do not necessarily apply to the position taken up by the processing device when in operation.

1-22. (canceled)

23. A device for optical processing of at least one main optical beam, comprising:
an optical transforming module optically transforming or contributing towards optical transformation of the main optical beam input into the processing device, including a plurality of discrete elements arranged in one same plane;
an upstream spatial configuration module upstream of the optical transforming module;
a first optical pathway through which the main optical beam travels, the first pathway comprising one or more first mobile optical deflection elements configured to cause the main optical beam to take up potential spatial positions in the plane of the optical transforming module, the potential spatial positions coinciding with those of the discrete elements; and
a second optical pathway through which an optical beam is able to travel derived from reflection of the main optical beam on the optical transforming module, the second optical pathway comprising one or more of the first mobile optical deflection elements.

24. A device according to claim 23, wherein among the discrete elements at least one is active and at least one is inactive.

25. A device according to claim 23, wherein the discrete elements are static.

26. A device according to claim 24, wherein one active discrete element has a spectral filtering, or an attenuating, or an absorbing function.

27. A device according to claim 26, wherein the discrete element has the filtering function and comprises a filtering thin layer or plural stacked filtering thin layers.

28. A device according to claim 23, wherein at least two of the discrete elements are active and different.

29. A device according to claim 23, wherein at least one discrete element is duplicated.

30. A device according to claim 23, wherein the discrete elements are arranged in an array.

31. A device according to claim 23, further comprising, downstream of the optical transforming module, a downstream spatial configuration module having a third optical pathway through which an optical beam is able to travel that has passed through the optical transforming module, the third optical pathway comprising one or more second mobile optical deflection elements.

32. A device according to claim 31, wherein the downstream spatial configuration module comprises a fourth optical pathway configured for insertion of an auxiliary optical beam towards the optical transforming module, the pathway comprising one or more of the second mobile optical deflection elements.

33. A device according to claim 23, wherein one of the discrete elements is inactive and is transparent to the main optical beam and/or to the auxiliary optical beam.

34. A device according to claim 23, wherein the optical transforming module is configured to filter individually and/or accumulated fashion plural wavelengths contained in the main optical beam and/or in the auxiliary optical beam.

35. A device according to claim 23, wherein each first mobile optical deflection element has digital control.

36. A device according to claim 31, wherein the upstream and downstream spatial configuration modules are symmetrical relative to the optical transforming module.

37. A device according to claim 31, wherein each spatial configuration module comprises an angle-position transforming element positioned between the first mobile optical deflection elements and the optical transforming module.

38. A device according to claim 37, wherein the angle-position transforming element has an object focal plane and an image focal plane, and the optical transforming module is positioned substantially in the image focal plane of the angle-position transforming element of the upstream spatial configuration module, and in the object focal plane of the angle-position transforming element of the downstream spatial configuration module.

39. A device according to claim 37, wherein the angle-position transforming element is common to all the optical pathways of its receiving spatial configuration module.

40. A device according to claim 23, wherein the first mobile optical deflection elements include mirrors configured to tilt about at least one axis.

41. A device according to claim 23, wherein the optical transforming module is interchangeable.

42. A device according to claim 23, wherein the optical transforming module comprises a support provided with plural wells configured to contain liquid samples to be tested, the sample-containing wells forming the discrete elements.

43. A device according to claim 42, wherein at least one of the wells includes a base part that is reflective or transparent.

44. A device according to claim 42, wherein one of the discrete elements includes a filter or attenuator function or is excitable when it contains a liquid sample to be tested.
